(19) United States
(12) Patent Application Publication
(10) Pub. No.: US 2025/0391200 A1
(43) Pub. Date: Dec. 25, 2025

(54) IRIS FEATURE ACQUISITION AND OBJECT IDENTIFICATION

(71) Applicant: Tencent Technology (Shenzhen) Company Limited, Shenzhen (CN)

(72) Inventors: Weipeng YAO, Shenzhen (CN); Yuge HUANG, Shenzhen (CN); Jiazhen JI, Shenzhen (CN); Jianqing XU, Shenzhen (CN)

(73) Assignee: Tencent Technology (Shenzhen) Company Limited, Shenzhen, GD (CN)

(21) Appl. No.: 19/312,175

(22) Filed: Aug. 27, 2025

Related U.S. Application Data
(63) Continuation of application No. PCT/CN2024/093741, filed on May 16, 2024.

(30) Foreign Application Priority Data
Jul. 19, 2023 (CN) . 202310891383.5

(51) Int. Cl. G06V 40/18; G06F 18/25; G06T 7/12; G06T 7/73; G06V 10/141; G06V 10/86

(52) U.S. Cl. CPC G06V 40/193; G06F 18/251; G06T 7/12; G06T 7/73; G06V 10/141; G06V 10/86; G06V 40/197; G06T 2207/10048; G06T 2207/30041

(57) ABSTRACT

An iris feature acquisition policy of an iris identification device for a user is determined, the iris feature acquisition policy indicates a manner of acquiring an iris feature by using light spot imaging, and the iris feature acquisition policy includes one or more light spot imaging modes. One or more light spot iris images of the user are acquired based on the one or more light spot imaging modes and by using the iris identification device. Feature extraction is performed respectively on the one or more light spot iris images to obtain one or more light spot iris features. A light spot iris identification feature of the user under the iris feature acquisition policy is determined based on the one or more light spot iris features. The light spot iris identification feature is stored with identification information of the user into a database associated with the iris identification device.

### RELATED APPLICATIONS

The present application is a continuation of International Application No. PCT/CN2024/093741, filed on May 16, 2024, which claims priority to Chinese Patent Application No. 202310891383.5, filed on Jul. 19, 2023. The entire disclosures of the prior applications are hereby incorporated by reference.

### FIELD OF THE TECHNOLOGY

This disclosure relates to the field of artificial intelligence (AI) technologies, including an iris feature acquisition method and apparatus, an object identification method and apparatus, a device, a medium, and a product.

### BACKGROUND OF THE DISCLOSURE

With the development of Internet technologies, an identity identification technology has a broader application scenario. For example, the technology may be applied to electronic payment. Common identity identification may include fingerprint, face, palm print, and iris identification. The iris identification technology, one of human biometric identification technologies, is identity identification based on irises in eyes. An iris feature has uniqueness. This also determines uniqueness of identity identification. Therefore, the iris feature of the eye may be used for identity identification.

In a related technology, at an iris feature input stage, a single iris image of a user is generally directly acquired, an iris feature of the iris image is extracted, and the iris feature is stored into a database. In the process of iris identification, the acquired single iris image of the user is directly matched with the iris features in the database, so as to determine a user identity according to a matching result.

However, iris information of the user is easily leaked, and the iris information of the user is easily stolen, causing security risks to the user. Therefore, a current iris feature input manner has relatively low security.

### SUMMARY

Embodiments of this disclosure provide an iris feature acquisition method and apparatus, an object identification method and apparatus, a device, a medium, and a product.

Some aspects of the disclosure provide a method of iris feature acquisition. In some examples, an iris feature acquisition policy of an iris identification device for a user is determined, the iris feature acquisition policy indicates a manner of acquiring an iris feature by using light spot imaging, and the iris feature acquisition policy includes one or more light spot imaging modes, the iris feature acquisition policy is determined based on at least one of information of the iris identification device and information of the user. One or more light spot iris images of the user are acquired respectively based on the one or more light spot imaging modes, by using the iris identification device. The one or more light spot imaging modes indicate light spot imaging attributes of the iris identification device. Feature extraction is performed respectively on the one or more light spot iris images to obtain one or more light spot iris features respectively in the one or more light spot imaging modes. A light spot iris identification feature of the user under the iris feature acquisition policy is determined based on the one or more light spot iris features respectively in the one or more light spot imaging modes. The light spot iris identification feature of the user under the iris feature acquisition policy is stored with identification information of the user into a database associated with the iris identification device.

Some aspects of the disclosure provide an apparatus that includes processing circuitry configured to perform the method of iris feature acquisition.

Some aspects of the disclosure also provide a non-transitory computer-readable storage medium storing instructions which when executed by at least one processor cause the at least one processor to perform the method of iris feature acquisition.

Some aspects of the disclosure provide a method of object identification. In some examples, a target iris feature acquisition policy of an iris identification device for a to-be-identified object is determined, the target iris feature acquisition policy indicates a manner of acquiring an iris feature of the to-be-identified object by using light spot imaging, the target iris feature acquisition policy includes one or more light spot imaging modes, the target iris feature acquisition policy is determined based on at least one of information of the iris identification device and information of the to-be-identified object. One or more light spot iris images of the to-be-identified object are acquired respectively based on the one or more light spot imaging modes and by using the iris identification device. The one or more light spot imaging modes indicate light spot imaging attributes of the iris identification device. Feature extraction is performed respectively on the one or more light spot iris images, to obtain one or more light spot iris features respectively in the one or more light spot imaging modes. A target light spot iris identification feature of the to-be-identified object is determined based on the one or more light spot iris features respectively in the one or more light spot imaging modes. The target light spot iris identification feature is matched with iris data stored in a database associated with the iris identification device, to determine identity information of the to-be-identified object, the iris data includes light spot iris identification features with respective identity information.

Some aspects of the disclosure provide an apparatus that includes processing circuitry configured to perform the method of object identification.

Some aspects of the disclosure also provide a non-transitory computer-readable storage medium storing instructions which when executed by at least one processor cause the at least one processor to perform the method of object identification.

According to an aspect, an iris feature acquisition method is provided. The method is performed by an electronic device, and includes: determining an iris feature acquisition policy of an iris identification device for a user, where the iris feature acquisition policy indicates a manner of acquiring an iris feature by using light spot imaging, and the iris feature acquisition policy includes at least one light spot imaging mode; acquiring, by the iris identification device, a light spot-projected iris image of the user based on a light spot imaging attribute indicated by the light spot imaging mode, so as to obtain a light spot iris image in the light spot imaging mode; performing feature extraction on the light spot iris image in the light spot imaging mode, to obtain a light spot iris feature in the light spot imaging mode; determining a light spot iris feature of the user (also referred to as light spot iris identification feature of the user) under the iris feature acquisition policy based on the light spot iris feature in the light spot imaging mode; and storing the light spot iris feature of the user under the iris feature acquisition policy into a database associated with the iris identification device.

According to another aspect, an object identification method is provided. The method is performed by an electronic device, and includes: determining a target iris feature acquisition policy of an iris identification device for a to-be-identified object, where the target iris feature acquisition policy indicates a manner of acquiring an iris feature of the to-be-identified object by using light spot imaging, and the target iris feature acquisition policy includes at least one light spot imaging mode; acquiring, by the iris identification device, a light spot-projected iris image of the to-be-identified object based on a light spot imaging attribute indicated by the light spot imaging mode, so as to obtain a light spot iris image in the light spot imaging mode; performing feature extraction on the light spot iris image in the light spot imaging mode, to obtain a light spot iris feature in the light spot imaging mode; determining a target light spot iris feature of the to-be-identified object under the target iris feature acquisition policy based on the light spot iris feature in the light spot imaging mode; and matching the target light spot iris feature with iris data stored in a database associated with the iris identification device, to perform identity identification on the to-be-identified object and determine identity information of the to-be-identified object, where the iris data includes at least one light spot iris feature.

According to still another aspect, an iris feature acquisition apparatus is provided, including: a first policy determining unit, configured to determine an iris feature acquisition policy of an iris identification device for a user, where the iris feature acquisition policy indicates a manner of acquiring an iris feature by using light spot imaging, and the iris feature acquisition policy includes at least one light spot imaging mode; a first acquisition unit, configured to acquire, by the iris identification device, a light spot-projected iris image of the user based on a light spot imaging attribute indicated by the light spot imaging mode, so as to obtain a light spot iris image in the light spot imaging mode; a first extraction unit, configured to perform feature extraction on the light spot iris image in the light spot imaging mode, to obtain a light spot iris feature in the light spot imaging mode; a first feature determining unit, configured to determine a light spot iris feature of the user (also referred to as light spot iris identification feature of the user) under the iris feature acquisition policy based on the light spot iris feature in the light spot imaging mode; and a storage unit, configured to store the light spot iris feature of the user under the iris feature acquisition policy into a database associated with the iris identification device.

According to yet another aspect, an embodiment of this disclosure provides an object identification apparatus, including: a second policy determining unit, configured to determine a target iris feature acquisition policy of an iris identification device for a to-be-identified object, where the target iris feature acquisition policy indicates a manner of acquiring an iris feature of the to-be-identified object by using light spot imaging, and the target iris feature acquisition policy includes at least one light spot imaging mode; a second acquisition unit, configured to acquire, by the iris identification device, a light spot-projected iris image of the to-be-identified object based on a light spot imaging attribute indicated by the light spot imaging mode, so as to obtain a light spot iris image in the light spot imaging mode; a second extraction unit, configured to perform feature extraction on the light spot iris image in the light spot imaging mode, to obtain a light spot iris feature in the light spot imaging mode; a second feature determining unit, configured to determine a target light spot iris feature of the to-be-identified object under the target iris feature acquisition policy based on the light spot iris feature in the light spot imaging mode; and an identification unit, configured to match the target light spot iris feature with iris data stored in a database associated with the iris identification device, to perform identity identification on the to-be-identified object and determine identity information of the to-be-identified object, where the iris data includes at least one light spot iris feature.

According to yet another aspect, an electronic device is provided, including a processor and a memory. The memory has a plurality of instructions stored therein. The processor loads the instructions to perform the operations of the iris feature acquisition method and the object identification method provided in the foregoing embodiments of this disclosure.

According to yet another aspect, a computer-readable storage medium is provided, having a computer program stored therein. The computer program, when executed by a processor, implements the operations of the iris feature acquisition method and the object identification method provided in the foregoing embodiments of this disclosure.

According to yet another aspect, a computer program product is provided, including a computer program or instruction. The computer program or instruction, when executed by a processor, implements the operations of the iris feature acquisition method and the object identification method provided in the foregoing embodiments of this disclosure.

Details of one or more embodiments of this disclosure are provided in the accompanying drawings and descriptions below. Other features, objectives, and advantages of this disclosure become apparent from the specification, the drawings, and the claims.

### BRIEF DESCRIPTION OF THE DRAWINGS

FIG. 1 is a schematic scenario diagram of an iris feature acquisition method and an object identification method according to an embodiment of this disclosure.

FIG. 2 is a flowchart of an iris feature acquisition method according to an embodiment of this disclosure.

FIG. 3 is a schematic device diagram of an iris feature acquisition method and an object identification method according to an embodiment of this disclosure.

FIG. 4 is an illustration diagram of an iris feature acquisition method and an object identification method according to an embodiment of this disclosure.

FIG. 5 is another illustration diagram of an iris feature acquisition method and an object identification method according to an embodiment of this disclosure.

FIG. 6 is another illustration diagram of an iris feature acquisition method and an object identification method according to an embodiment of this disclosure.

FIG. 7 is another illustration diagram of an iris feature acquisition method and an object identification method according to an embodiment of this disclosure.

FIG. 8 is another illustration diagram of an iris feature acquisition method and an object identification method according to an embodiment of this disclosure.

FIG. 9 is another illustration diagram of an iris feature acquisition method and an object identification method according to an embodiment of this disclosure.

FIG. 10 is another illustration diagram of an iris feature acquisition method and an object identification method according to an embodiment of this disclosure.

FIG. 11 is another illustration diagram of an iris feature acquisition method and an object identification method according to an embodiment of this disclosure.

FIG. 12 is another illustration diagram of an iris feature acquisition method and an object identification method according to an embodiment of this disclosure.

FIG. 13 is a flowchart of an object identification method according to an embodiment of this disclosure.

FIG. 14 is another flowchart of an iris feature acquisition method and an object identification method according to an embodiment of this disclosure.

FIG. 15 is a schematic page diagram of an iris feature acquisition method and an object identification method according to an embodiment of this disclosure.

FIG. 16 is a schematic structural diagram of an iris feature acquisition apparatus according to an embodiment of this disclosure.

FIG. 17 is a schematic structural diagram of an object identification apparatus according to an embodiment of this disclosure.

FIG. 18 is a schematic structural diagram of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Embodiments of this disclosure provide an iris feature acquisition method and apparatus, an object identification method and apparatus, a device, a medium, and a product.

In an example, an embodiment of this disclosure provides an iris feature acquisition apparatus applicable to a first electronic device. The first electronic device may be a device such as a terminal. An embodiment of this disclosure further provides an object identification apparatus applicable to a second electronic device. The second electronic device may be a device such as a terminal.

As shown in FIG. 1, an example in which the terminal and the server jointly perform the iris feature acquisition method and the object identification method is used. An iris feature acquisition and object identification system provided in an embodiment of this disclosure includes a terminal 10, a server 11, and the like. The terminal 10 and the server 11 are connected by using a network, for example, are connected by using a wired or wireless network. The iris feature acquisition apparatus and the object identification apparatus may be integrated into the terminal.

In one embodiment, the terminal 10 may be configured to: determine an iris feature acquisition policy of an iris identification device for a user, where the iris feature acquisition policy indicates a manner of acquiring an iris feature by using light spot imaging, and the iris feature acquisition policy includes at least one light spot imaging mode; acquire, by the iris identification device, a light spot-projected iris image of the user based on a light spot imaging attribute indicated by the light spot imaging mode, so as to obtain a light spot iris image in the light spot imaging mode; perform feature extraction on the light spot iris image in the light spot imaging mode, to obtain a light spot iris feature in the light spot imaging mode; determine a light spot iris feature of the user (also referred to as light spot iris identification feature of the user) under the iris feature acquisition policy based on the light spot iris feature in the light spot imaging mode; and transmit the light spot iris feature of the user under the iris feature acquisition policy to the server 11, so as to store the light spot iris feature into a database associated with the iris identification device by using the server 11. The terminal 10 may include a mobile phone, a smart voice interaction device, a smart home appliance, an in-vehicle terminal, a virtual reality (VR) device, an aircraft, a tablet computer, a laptop, or a personal computer (PC), and the like. The terminal 10 may be further provided with a client. The client may be an application client, a browser client, or the like.

The server 11 may be configured to: receive the light spot iris feature, transmitted by the terminal 10, of the user under the iris feature acquisition policy, and store the light spot iris feature of the user under the iris feature acquisition policy into a database associated with the iris identification device. The server 11 may be an independent physical server, or may be a server cluster or a distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform.

In another embodiment, the terminal 10 may be configured to: determine a target iris feature acquisition policy of an iris identification device for a to-be-identified object, where the target iris feature acquisition policy indicates a manner of acquiring an iris feature of the to-be-identified object by using light spot imaging, and the target iris feature acquisition policy includes at least one light spot imaging mode; acquire, by the iris identification device, a light spot-projected iris image of the to-be-identified object based on a light spot imaging attribute indicated by the light spot imaging mode, so as to obtain a light spot iris image in the light spot imaging mode; transmit the light spot iris image in the light spot imaging mode to the server 11, so as to perform identity identification on the to-be-identified object by using the server 11 based on the light spot iris image in the light spot imaging mode; and receive identity information of the to-be-identified object transmitted by the server 11.

The server 11 may be configured to: receive the light spot iris image,

transmitted by the terminal 10, in the light spot imaging mode, and perform feature extraction on the light spot iris image in the light spot imaging mode, to obtain a light spot iris feature in the light spot imaging mode; determine a target light spot iris feature of the to-be-identified object under the target iris feature acquisition policy based on the light spot iris feature in the light spot imaging mode; match the target light spot iris feature with iris data stored in a database associated with the iris identification device, to perform identity identification on the to-be-identified object and determine identity information of the to-be-identified object, where the iris data includes at least one light spot iris feature; and finally, transmit the identity information of the to-be-identified object to the terminal 10.

The iris feature acquisition method and the object identification method provided by the foregoing embodiments of this disclosure relate to a technical direction of computer vision (CV) in the field of AI, and relate to an iris identification technology.

AI is a theory, a method, a technology, and an application system that use a digital computer or a machine controlled by the digital computer to simulate, extend, and expand human intelligence, so as to sense an environment, obtain knowledge, and obtain an optimal result with knowledge. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making. The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, a pretrained model technology, an operating/interaction system, and electromechanical integration. The pretrained model is also referred to as a large model or a basic model. After fine tuning, the pretrained model may be widely applied to downstream tasks in various large directions of AI. AI software technologies mainly include several major directions such as a CV technology, a speech processing technology, a natural language processing technology, and machine learning/deep learning.

The CV technology is a science that studies how to use a machine to “see”, and the computer vision further refers to using a camera and a computer instead of human eyes to implement machine vision, such as identification and measurement of a target, and further perform graphic processing, so that the computer processes the target into an image more suitable for human eyes to observe, or an image transmitted to an instrument for detection. As a scientific discipline, CV studies related theories and technologies and attempts to establish an AI system that can obtain information from images or multidimensional data. Large model technologies bring an important change to development of the CV technology. Pretrained models in vision fields such as swin-transformer, ViT, V-MOE, and MAE may be quickly and widely applied to specific downstream tasks after fine tuning. The CV technology generally includes technologies such as image processing, image identification, image semantic understanding, image retrieval, optical character identification (OCR), video processing, video semantic understanding, video content/behavior identification, three-dimensional object reconstruction, 3D technologies, virtual reality (VR), augmented reality (AR), synchronous positioning, and map building, and further includes common biometric identification technologies such as face identification, fingerprint identification, and iris identification.

The iris identification technology is a technology for identifying a human identity based on iris texture information in an eye, and is a biometric identification technology belonging to AI. A structure of the human eye includes parts such as a sclera, an iris, a pupil, a crystalline lens, and a retina. The iris is an annular part located between the black pupil and the white sclera, and includes many detailed features such as spots, threads, crowns, stripes, and crypts that are staggered with each other. An iris feature has uniqueness. This also determines uniqueness of identity identification. Therefore, the iris feature of the eye may be used for identity identification.

Detailed descriptions are separately provided below. A description order of the following embodiments is not used as a limitation on the priority order of the embodiments.

This embodiment is described from a perspective of an iris feature acquisition apparatus. The iris feature acquisition apparatus may be integrated into a first electronic device. The first electronic device may be a device such as a server or a terminal.

This embodiment may be applied to various scenarios such as cloud technology, AI, intelligent transportation, and assisted driving.

In a specific implementation of this disclosure, relevant data such as user information (for example, an iris) is involved. In a case that the foregoing embodiments of this disclosure are applied to a specific product or technology, a permission or consent of a user is required, and collection, use, and processing of the relevant data need to comply with relevant laws, regulations, and standards of relevant countries and regions.

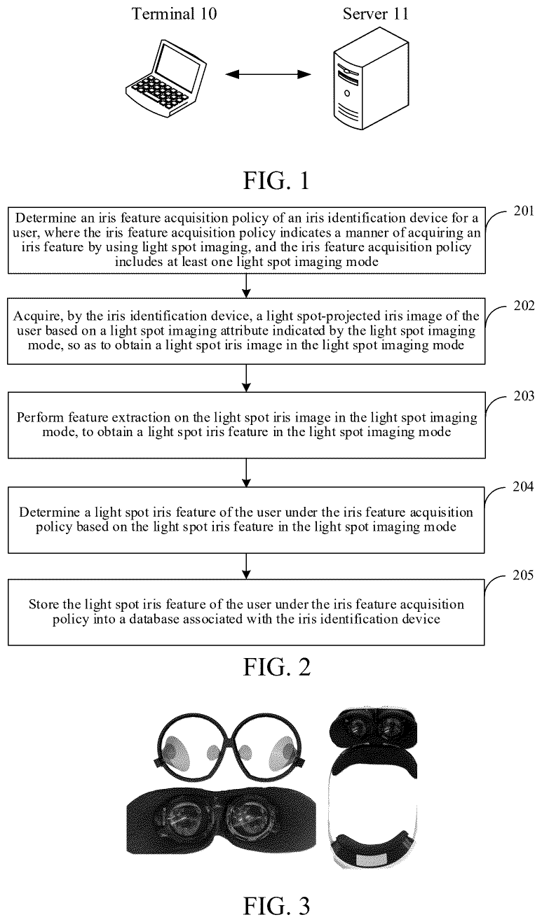

As shown in FIG. 2, the iris feature acquisition method may include the following detailed process.

201: Determine an iris feature acquisition policy of an iris identification device for a user, where the iris feature acquisition policy indicates a manner of acquiring an iris feature by using light spot imaging, and the iris feature acquisition policy includes at least one light spot imaging mode.

The iris identification device may be configured to acquire an iris feature and perform identity identification on the acquired iris image. For example, the iris identification device may be VR glasses, a door lock, a safe, or the like. A device form of the VR device may be shown in FIG. 3. The iris identification device may be the first electronic device or a second electronic device, or may be an independent device connected to the first electronic device or the second electronic device.

The user is a natural person to which a light spot iris feature that needs to be acquired belongs. The acquired light spot iris feature may be used for subsequent iris identification.

The iris feature acquisition policy may be set by the iris identification device, or may be user-defined. In an example, different devices may use different iris feature acquisition policies. In this way, differences between devices may be supported, so that an iris feature acquired by device A can be used only by device A but cannot be used by device B, thereby improving the security of iris identification. In addition, different users may also self-define iris feature acquisition policies belonging to the users. The defined iris feature acquisition policy may be used for each iris identification.

In an example, the iris feature acquisition policy includes at least one light spot imaging mode. The light spot imaging mode may be a mode in which a light spot is formed on an iris when the iris is imaged. The light spot may be formed by using a mask. The mask may be located in front of an infrared lamp or a camera lens of the iris identification device. In some embodiments, shapes of masks of different iris identification devices may be different. In this way, shapes of light spots formed under the masks of different shapes are also different. Therefore, the different iris identification devices have different iris feature acquisition policies, thereby differentiating devices of the iris feature acquisition policies, and improving the security of iris identification.

Different light spot imaging modes indicate different light spot imaging attributes. The light spot imaging attribute may refer to an imaging attribute of a light spot on an iris. The imaging attribute herein may include a distribution position of the light spot on the iris, a shape of the light spot, a lighting sequence of the light spot, and the like. This is not limited in this embodiment. The lighting sequence of the light spot is a sequence of executing the light spot imaging modes in the iris feature acquisition policy.

For example, an iris feature acquisition policy may be first applying a light spot below an iris, then applying a light spot above the iris, and finally applying a light spot on the right of the iris. The iris feature acquisition policy includes three light spot imaging modes. The three light spot imaging modes are respectively: applying a light spot below an iris, applying a light spot above the iris, and applying a light spot on the right of the iris.

In an example, an iris identification technical solution mainly includes the following five operations:

1. Iris image acquisition: An iris of a subject is photographed and acquired by using a device such as an iris camera, to obtain an iris image.

2. Iris image preprocessing: The acquired iris image is preprocessed, including operations such as image denoising, cutting, and enhancement, to improve quality of the iris image.

3. Feature extraction: An independent identification feature of the iris is extracted by using information such as a texture feature and a stability feature in the iris image, and an iris feature template library is established according to the extracted independent identification feature of the iris.

4. Matching and identification: A to-be-identified iris image is compared and matched with stored iris feature templates, to confirm iris identity information.

5. Decision output: Determining is performed according to a matching score and a threshold, an iris identification result is outputted, and authentication or rejection is determined based on the iris identification result.

In a current related technology, matching is usually performed by using a single frame of iris image. In this way, iris information of a user may be easily stolen, causing security risks to the user.

According to the iris feature acquisition method of this disclosure, light spot imaging may be fused to iris information, thereby achieving a protection function. In an example, in this disclosure, a unique feature may be calculated by fusing a plurality of frames with reference to light spot imaging of a specific device, and a single-frame iris feature of a user is not directly used. In this way, an iris biometric feature can be better protected, and differential adaptation can further be performed for a device, so that a feature acquired by device A can be used only by device A but cannot be used by device B.

At an iris feature input stage, if a user inputs a light spot iris feature by using a target iris feature acquisition policy, the user needs to acquire an iris image by using a same target iris feature acquisition policy at an iris identification stage, to successfully identify an identity of the user. The same target iris feature acquisition policy herein may mean that attributes are the same. The same attributes may include a same sequence of light spot imaging modes, a same shape of a light spot, a same position of a light spot on an iris, and the like.

202: Acquire, by the iris identification device, a light spot-projected iris image of the user based on a light spot imaging attribute indicated by the light spot imaging mode, so as to obtain a light spot iris image in the light spot imaging mode.

The light spot iris image in the light spot imaging mode includes a light spot formed in the light spot imaging mode. In an example, the light spot iris image may be an infrared image. FIG. 4 shows a light spot iris image acquired by an iris identification device, where a light spot is fused.

In an example, in an iris feature acquisition module of the iris identification device, an infrared image is acquired. An infrared lamp is mapped to an iris of a user, and a light spot is formed. When eyeballs of the user move to different angles, there is a difference in light spot imaging, and there is a difference in iris features obtained through calculation in this way. Similarly, different lighting manners may also cause differences in light spot imaging. Therefore, in some embodiments, different devices may use different lighting manners to differentiate devices for iris identification.

In this embodiment, for different light spot imaging modes, moving directions of the eyeballs of the user may be different. Alternatively, for different light spot imaging modes, different lighting manners may be used. The different lighting manners herein may include different lighting angles, different light spot shapes, or the like. In this way, different light spot imaging modes correspondingly form different light spots, a plurality of frames of different light spot imaging images can be obtained, and all the light spot imaging images are fused into a unique feature.

In this embodiment, the operation of acquiring, by the iris identification device, a light spot-projected iris image of the user based on a light spot imaging attribute indicated by the light spot imaging mode, so as to obtain a light spot iris image in the light spot imaging mode may include:

guiding, by the iris identification device, the user to move eyeballs based on the light spot imaging attribute indicated by the light spot imaging mode, to acquire the light spot-projected iris image of the user, so as to obtain the light spot iris image in the light spot imaging mode.

For example, if the light spot imaging attribute indicated by the light spot imaging mode is that the light spot is applied to the right of the iris, the user may be guided to move the eyeballs to a corresponding angle, so that the light spot is applied to the right of the iris.

In a specific embodiment, the iris identification device may include a display screen. The display screen may present information for guiding the user to move the eyeballs. The user may alternatively be guided to move the eyeballs in another manner.

In this embodiment, the iris identification device includes an image acquisition module and at least one infrared light module.

The operation of acquiring, by the iris identification device, a light spot-projected iris image of the user based on a light spot imaging attribute indicated by the light spot imaging mode, so as to obtain a light spot iris image in the light spot imaging mode may include: controlling a lighting manner of the infrared light module to be switched to a target lighting manner based on the light spot imaging attribute indicated by the light spot imaging mode; and acquiring, by the image acquisition module, the light spot-projected iris image of the user based on the target lighting manner, so as to obtain the light spot iris image in the light spot imaging mode.

The image acquisition module may be an image shooting module such as a camera. The lighting manner of the infrared light module may include a lighting angle of an infrared lamp, a correspondingly formed light spot shape, and the like.

For example, if the light spot imaging attribute indicated by the light spot imaging mode is that the light spot is applied to the right of the iris, a lighting angle of the infrared lamp module may be controlled, so that the formed light spot is applied to the right of the iris.

In one embodiment, the operation of controlling a lighting manner of the infrared light module to be switched to a target lighting manner based on the light spot imaging attribute indicated by the light spot imaging mode may include: controlling an on-off state of each infrared light module based on the light spot imaging attribute indicated by the light spot imaging mode, to switch the lighting manner of the infrared light module to the target lighting manner. In one embodiment, the operation of controlling a lighting manner of the infrared light module to be switched to a target lighting manner based on the light spot imaging attribute indicated by the light spot imaging mode may include: moving a position of the infrared light module based on the light spot imaging attribute indicated by the light spot imaging mode, to switch the lighting manner of the infrared light module to the target lighting manner.

The infrared lamp on the iris identification device may be controlled to be on and off in a preset manner, so as to implement lighting at different angles. The infrared lamp module may alternatively be moved on the iris identification device in a preset motion manner, so as to implement lighting at different angles.

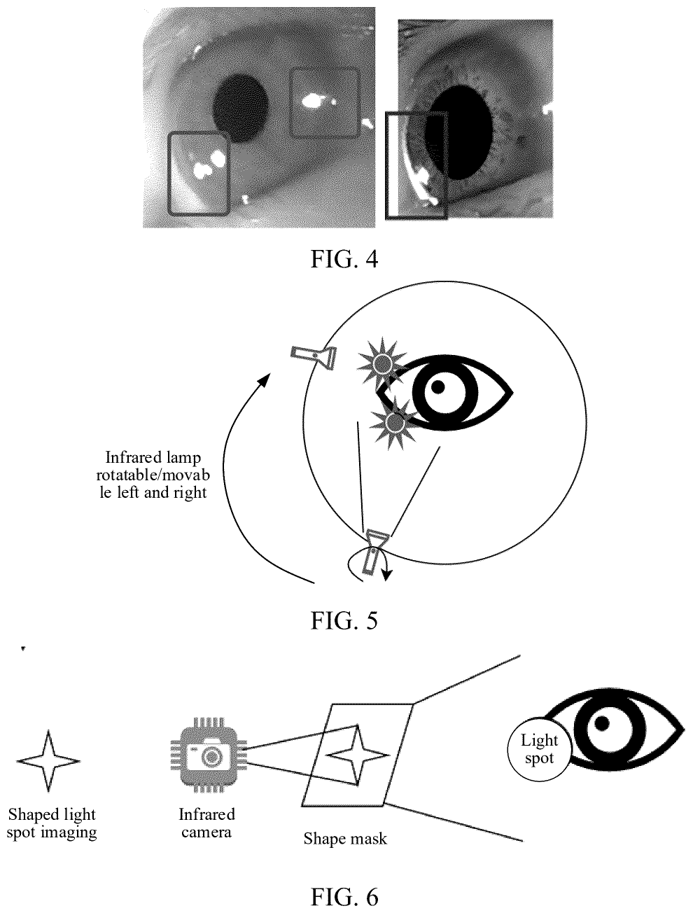

In some embodiments, as shown in FIG. 5, the infrared lamp on the iris identification device may support a plurality of lighting angles by rotating or moving left and right, to image different light spots and acquire different light spot effect frames. The rotation/motion of the infrared lamp is not necessary. In some other embodiments, a plurality of infrared lamps may be provided, and a plurality of lighting angles are implemented by controlling the infrared lamps to be on and off.

As shown in FIG. 6, the shape of the light spot may be user-defined in this embodiment. In an example, the shape of the light spot may be changed by using a mask. The mask may be mainly divided into a lens mask and a lamp light mask. For the lens mask, the mask is placed in front of the camera lens of the infrared camera. For the lamp light mask, the mask is placed in front of the infrared lamp. FIG. 6 shows the lens mask. A formed light spot may have a corresponding shape by using four-pointed star holes in the middle of the shape mask.

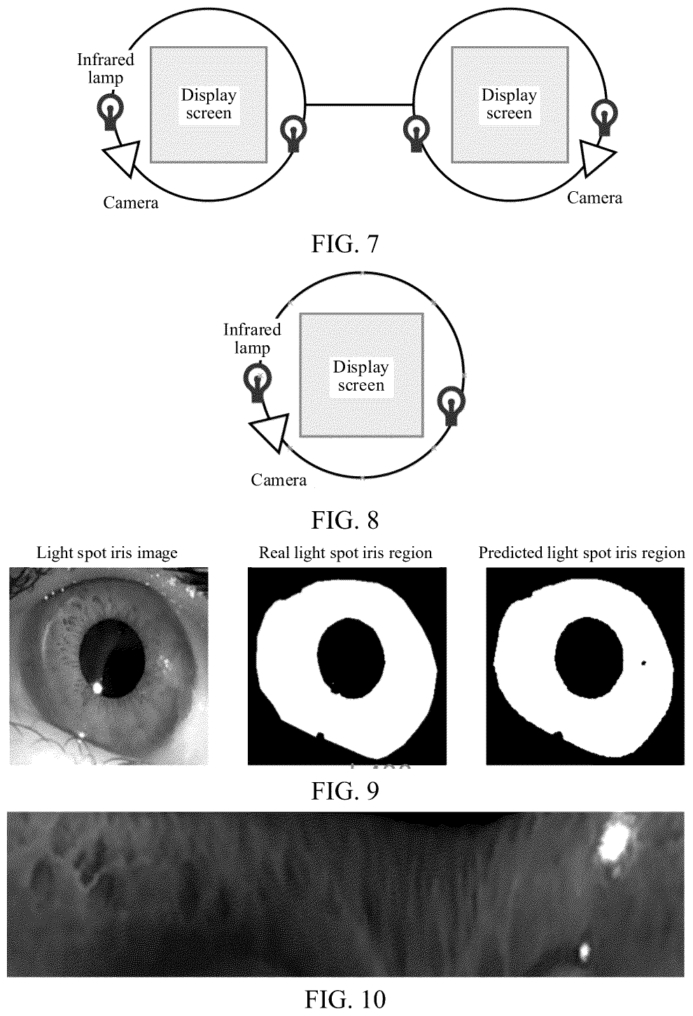

In a specific scenario, FIG. 7 shows a schematic diagram of a holder for performing iris identification with two eyes. A display screen in FIG. 7 is not necessary, and there may be no display screen. FIG. 8 shows a schematic diagram of a holder for performing iris identification with a single eye. Similarly, a display screen in FIG. 8 is not necessary, and there may be no display screen. In this embodiment, a glasses holder equipped with an infrared supplementary lamp and an infrared camera is needed to support acquisition of iris information. The glasses holder may be a part of the iris identification device.

The infrared lamp light needs to be capable of implementing lighting at different angles, so that the camera captures different light spot iris images. In an example, the infrared lamp may be designed to be static and fixed, or may be designed to be movable and rotatable, and a motion manner is allowed to be controlled by a device, so as to implement lighting at different angles. In addition, a plurality of infrared lamps may alternatively be provided according to requirements, and lighting at different angles is implemented by controlling the plurality of infrared lamps to be on and off. In some embodiments, the user may be required to move the eyeballs during identification, to form different light spot features. For example, the user may be guided to move the eyeballs by using a display screen. The display screen may not be needed if the user can learn the operation manner in another manner.

In this embodiment, methods such as a lens mask and a lamp light mask may be used to self-define a light spot shape to implement device differentiation. Different devices may use different light spot shapes. For example, a shape of a mask used by device A may be circular, and a shape of a mask used by device B may be rhombus. In this way, the two devices form different light spot shapes.

The device differentiation may alternatively be implemented in another manner. For example, the device differentiation may be implemented by using a lighting direction. For example, a lighting direction of an iris feature acquisition policy of device A is above and below an iris, and a lighting direction of an iris feature acquisition policy of device B is on the left and right of the iris.

In this embodiment, the light spot imaging modes in the iris feature acquisition policy are arranged in a preset acquisition sequence. The operation of acquiring, by the iris identification device, a light spot-projected iris image of the user based on a light spot imaging attribute indicated by the light spot imaging mode, so as to obtain a light spot iris image in the light spot imaging mode may include: determining a target light spot imaging mode to be currently executed from the iris feature acquisition policy based on the preset acquisition sequence; acquiring, by the iris identification device, the light spot-projected iris image of the user based on the light spot imaging attribute indicated by the target light spot imaging mode, so as to obtain a light spot iris image in the target light spot imaging mode; determining a new target light spot imaging mode to be currently executed from the iris feature acquisition policy based on the preset acquisition sequence after the light spot iris image in the target light spot imaging mode passes quality detection; and returning to the operation of acquiring, by the iris identification device, a light spot-projected iris image of the user based on a light spot imaging attribute indicated by the light spot imaging mode, so as to obtain a light spot iris image in the light spot imaging mode, until a light spot iris image passing the quality detection in each light spot imaging mode in the iris feature acquisition policy is obtained.

Quality detection on the light spot iris image may include determining of iris eyelash blocking, determining of exposure, determining of eyelid blocking, and the like.

For example, the iris feature acquisition policy includes three light spot imaging modes. According to an acquisition sequence, the three light spot imaging modes are respectively: applying a light spot below an iris, applying a light spot above the iris, and applying a light spot on the right of the iris. Therefore, when a light spot iris image is acquired, a first light spot imaging mode may be used as a target light spot imaging mode. A light spot is applied below an iris, a light spot iris image with the light spot below the iris is acquired, and then quality detection is performed by using an optimal algorithm. After the quality detection is passed, a second light spot imaging mode may be used as a target light spot imaging mode. A light spot is applied above an iris, a light spot iris image with the light spot above the iris is acquired, and then quality detection is performed by using the optimal algorithm. After the quality detection is passed, a third light spot imaging mode may be used as a target light spot imaging mode. A light spot is applied on the right of an iris, a light spot iris image with the light spot on the right of the iris is acquired, and then quality detection is performed by using the optimal algorithm.

203: Perform feature extraction on the light spot iris image in the light spot imaging mode, to obtain a light spot iris feature in the light spot imaging mode.

In this embodiment, the operation of performing feature extraction on the light spot iris image in the light spot imaging mode, to obtain a light spot iris feature in the light spot imaging mode may include: performing iris segmentation processing on the light spot iris image in the light spot imaging mode, to obtain a light spot iris region in the light spot imaging mode; normalizing the light spot iris region to obtain a normalized light spot iris region; and performing feature extraction on the normalized light spot iris region, to obtain the light spot iris feature in the light spot imaging mode.

In an example, before the iris segmentation processing is performed, image preprocessing may be performed on an original light spot iris image in the light spot imaging mode. The image preprocessing herein may include a preprocessing operation such as filtering, histogram equalization, and grayscale. Image quality can be improved through the image preprocessing.

After the light spot iris region in the light spot imaging mode is obtained, quality detection may further be performed on the light spot iris region. The quality detection may include determining of iris eyelash blocking, determining of exposure, determining of eyelid blocking, and the like. A picture of higher quality may be screened out by means of the quality detection.

In this embodiment, the operation of performing iris segmentation processing on the light spot iris image in the light spot imaging mode, to obtain a light spot iris region in the light spot imaging mode may include: calculating gradient information of pixel points in the light spot iris image in the light spot imaging mode; selecting at least one target pixel point from the pixel points of the light spot iris image according to the gradient information; performing a connection operation on the target pixel points, to obtain a closed contour; and performing iris segmentation processing on the light spot iris image according to the closed contour, to obtain the light spot iris region in the light spot imaging mode.

Through the iris segmentation processing, the light spot iris region may be segmented from the light spot iris image. The iris segmentation processing segments the iris from an entire image. Therefore, inner and outer boundaries of the iris need to be positioned, and an edge of the iris may be extracted by using an edge detection algorithm such as a Canny edge detection operator. In an example, the inner and outer boundaries of the iris may be searched for by means of a gradient of an image grayscale to a position according to approximate annular characteristics of the inner and outer boundaries of the iris.

The gradient information of the pixel point may include information about a gradient magnitude and a gradient direction.

In a specific embodiment, before gradient calculation is performed, grayscale processing and smoothing processing may be performed on the light spot iris image in the light spot imaging mode. After the grayscale processing and the smoothing processing, a smoothed grayscale image is obtained. Then, gradient magnitude and direction calculation are performed on the smoothed grayscale image to obtain a corresponding gradient magnitude and direction image, where the gradient magnitude and the gradient direction may be respectively calculated by using the following Formula (1) and Formula (2):

$$G = \sqrt{{G}_{x}^{2} + {G}_{y}^{2}} \qquad ( 1 )$$

$$α = arctan \frac{{G}_{y}}{{G}_{x}} \qquad ( 2 )$$

where G represents the gradient magnitude, Gₓ and G_{y} respectively represent gradient values of an image in an x-axis direction and a y-axis direction, and α represents the gradient direction.

After the gradient magnitude and the gradient direction are obtained, pixels near the gradient direction may be screened by using a non-maximum suppression technology, and a pixel point with a maximum gradient magnitude is reserved as a target pixel point. In an example, an operation method of non-maximum value suppression may be: comparing each pixel point with two neighborhood pixel points having a same gradient. If a gradient value is not a maximum value of the three pixel points, the pixel point is suppressed. To be specific, a pixel value of the pixel point is zero, and a non-zero pixel point is a target pixel point finally. Non-edge pixel points may be eliminated by means of non-maximum suppression.

For target pixel points, the target pixel points may be divided into two parts: high-threshold and low-threshold according to gradient magnitudes thereof, the high-threshold pixel points are determined as foreground points, and the target pixel points are connected into an edge based on the foreground points. In an example, from the foreground points, a connection operation may be performed on the low-threshold pixel points and the foreground points, to form a closed contour, thereby obtaining a complete edge, and implementing iris segmentation.

FIG. 9 shows a light spot iris region obtained through segmentation from a light spot iris image by using the segmentation algorithm of the foregoing embodiment. A predicted light spot iris region is a light spot iris region obtained by using the foregoing segmentation algorithm. From FIG. 9, the predicted light spot iris region is almost the same as a real light spot iris region. Therefore, the foregoing segmentation algorithm has relatively high accuracy.

In an embodiment, the operation of normalizing the light spot iris region to obtain a normalized light spot iris region may be: converting different light spot iris regions into same features and metric scales, thereby facilitating subsequent feature extraction and matching. In an example, there are multiple iris normalization methods, for example, a polar coordinate transformation method and a strip projection method.

The method for implementing iris normalization based on strip projection is: projecting an annular light spot iris region into a strip-shaped light spot iris region. In an example, the iris image is converted into a strip having a fixed width. Different from the polar coordinate transformation, the strip projection method can better maintain information in horizontal and vertical directions in the iris image, and can eliminate impact of transformation such as zooming or translation in the image on the iris identification. This process may be represented by using the following Formula (3):

$$P ( x , y ) = I ( x cos θ + y sin θ ) \qquad ( 3 )$$

where P(x, y) is a projected strip-shaped image, and I(x, y) is an original iris image, namely a light spot iris region before normalization. FIG. 10 shows a normalized light spot iris region obtained through strip projection.

In this embodiment, the operation of performing feature extraction on the light spot iris image in the light spot imaging mode, to obtain a light spot iris feature in the light spot imaging mode may include: filtering the light spot iris image in the light spot imaging mode, to obtain a response function of each pixel point in the light spot iris image in the light spot imaging mode; extracting frequency information and direction information corresponding to the response function of each pixel point; and mapping the light spot iris image in the light spot imaging mode according to the frequency information and the direction information, to obtain the light spot iris feature in the light spot imaging mode.

The operation of performing feature extraction on the light spot iris image in the light spot imaging mode may include: performing iris segmentation processing on the light spot iris image in the light spot imaging mode, normalizing a light spot iris region obtained by segmentation, and then performing feature extraction on the normalized light spot iris region, to obtain the light spot iris feature in the light spot imaging mode.

The light spot iris feature includes a light spot iris frequency feature and a light spot iris direction feature.

In a specific embodiment, a proper group of Gabor filters may be selected and applied to the normalized light spot iris region, to obtain a response function of each pixel point. Details are shown in Formula (4) and Formula (5):

$$G ( x , y , λ , θ , ψ , γ ) = {e}^{\frac{- {x}^{2} + {γ}^{2} {y}^{2}}{2 {σ}^{2}}} cos ( 2 π \frac{x}{λ} + ψ ) \qquad ( 4 )$$

$$R ( x , y , λ , θ , ψ , γ ) = G ( x , y , λ , θ , ψ , γ ) * I ( x , y ) \qquad ( 5 )$$

where Formula (4) is a formula corresponding to the Gabor filter, Formula (5) is a formula corresponding to the response function, G represents the Gabor filter, R represents the response function, λ represents a spatial frequency, θ represents a direction, Ψ represents a phase offset, γ represents an aspect ratio, and I represents an input light spot iris image (in an example, the light spot iris region).

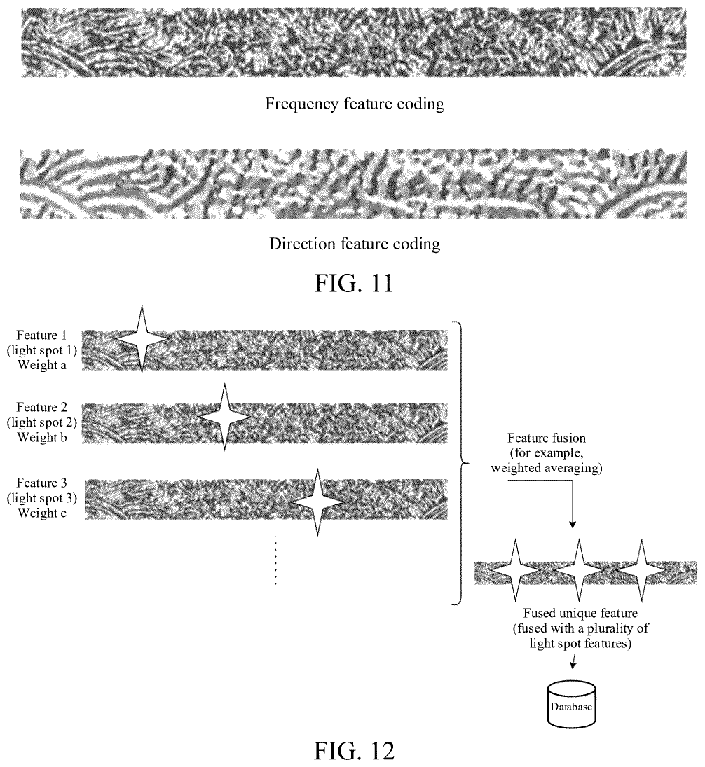

After the response function of each pixel point is obtained, frequency and direction extraction may be performed on the response function of each pixel point. To be specific, the frequency and direction of the response function are extracted by using the corresponding Gabor filters. Then, the frequency and direction features corresponding to the light spot iris region are mapped to a polar coordinate system. Then, binarization processing is performed by using a suitable threshold. A point greater than a preset threshold is set to 1, and a point not greater than the preset threshold is set to 0, to obtain a binary iris feature map. The binary iris feature map is the light spot iris feature of the foregoing embodiment, and may include frequency feature coding and direction feature coding, as shown in FIG. 11.

Gabor is a linear filter for edge extraction. Frequency and direction expressions thereof are similar to those of a human vision system. Good direction selection and scale selection characteristics can be provided, and Gabor is insensitive to illumination changes and is thus very suitable for texture analysis.

204: Determine a light spot iris feature of the user (also referred to as light spot iris identification feature of the user) under the iris feature acquisition policy based on the light spot iris feature in the light spot imaging mode.

In an example, the light spot iris features in the light spot imaging modes may be fused to obtain the light spot iris feature of the user under the iris feature acquisition policy. The fusion manner herein may include weighted averaging, and the like. This is not limited in this embodiment.

In one embodiment, different light spot imaging modes indicate different light spot imaging attributes. The operation of determining a light spot iris feature of the user under the iris feature acquisition policy based on the light spot iris feature in the light spot imaging mode may include: determining weight information respectively corresponding to the light spot iris features in the light spot imaging modes; and fusing the light spot iris features in the light spot imaging modes according to the weight information respectively corresponding to the light spot iris features in the light spot imaging modes, to obtain the light spot iris feature of the user for iris identification under the iris feature acquisition policy.

Weight information respectively corresponding to the light spot iris features in the light spot imaging modes may be determined according to a definition of the light spot iris feature in each light spot imaging mode.

In a specific embodiment, a corresponding weight may be assigned to the light spot iris feature in each light spot imaging mode, to represent importance thereof. The weight may be self-defined by an algorithm designer. For example, the weight may be evaluated according to the definition of the iris feature. Then, a weighted average value of the light spot iris features in all the light spot imaging modes is calculated as a final light spot iris feature representation, namely a light spot iris feature of the user under the iris feature acquisition policy.

For example, the iris feature acquisition policy includes n light spot imaging modes. Light spot iris features extracted therefrom are respectively ƒ₁, ƒ₂, . . . , ƒₙ, corresponding weights are ω₁, ω₂, . . . , ωₙ, and the final light spot iris feature representation may be represented by using Formula (6):

$$F = \frac{{\sum }_{i = 1}^{n} {ω}_{i} {f}_{i}}{{\sum }_{i = 1}^{n} {ω}_{i}} \qquad ( 6 )$$

where F is the final light spot iris feature representation, namely the light spot iris feature of the user under the iris feature acquisition policy.

205: Store the light spot iris feature of the user under the iris feature acquisition policy into a database associated with the iris identification device.

In an example, as shown in FIG. 12, light spot iris features obtained in different light spot imaging modes are different. In an example, because the light spot is distributed in the light spot iris image at different positions, the extracted light spot iris features are also different. Different weights may be given to different light spot iris features. For example, a weight for light spot iris feature 1 including light spot 1 may be set to a. A weight for light spot iris feature 2 including light spot 2 may be set to b. A weight for light spot iris feature 3 including light spot 3 may be set to c. After the light spot iris features in the light spot imaging modes are obtained, feature fusion, such as weighted averaging, may be performed on the light spot iris features obtained in all the light spot imaging modes, to obtain a fused unique feature (namely, the light spot iris feature under the iris feature acquisition policy in the foregoing embodiment). The feature is fused with a plurality of light spot features, and the feature is further stored into a database for subsequent iris identification.

According to the iris feature acquisition method provided in this disclosure, with reference to a difference between light spot imaging, a plurality of frames of light spot iris images are acquired to perform buffer fusion processing, thereby improving security and robustness of iris identification, and effectively preventing iris information of a user from being stolen. In an example, by changing a light spot position and shape of an eyeball, whether it is an eyeball sphere may be determined during identification, thereby preventing the iris identification device from being deceived by a theft using iris information recorded on a plane. For example, in a related technology, the iris identification device may be deceived by printing particular iris information on paper.

In addition, this disclosure may support user encryption, and confirm a corresponding iris feature acquisition policy according to the intention of the user. The user can define different light spot shapes, light spot positions, or lighting sequences, and use these light spot shapes, light spot positions, or lighting sequences as passwords to be inputted into an algorithm. Only when the corresponding light spot shapes, positions, and sequences are used for acquiring iris features, user identification can be passed.

In this embodiment, an iris feature acquisition policy of an iris identification device for a user is determined, where the iris feature acquisition policy indicates a manner of acquiring an iris feature by using light spot imaging, and the iris feature acquisition policy includes at least one light spot imaging mode. The iris identification device acquires a light spot-projected iris image of the user based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a light spot iris feature of the user (also referred to as light spot iris identification feature of the user) under the iris feature acquisition policy is determined. The light spot iris feature of the user under the iris feature acquisition policy is stored into a database associated with the iris identification device.

In this disclosure, an iris image may be encrypted by using light spot imaging, and corresponding encrypted iris features are stored into a database. When the light spot iris feature stored in the database is configured for iris identification, different from a related method of directly acquiring an iris feature of a to-be-identified object, for a to-be-identified object, only when an iris feature of the to-be-identified object is acquired by using a corresponding iris feature acquisition policy, the to-be-identified object can be identified by using an iris. If iris data of the database is leaked, because a real iris feature of a user cannot be directly obtained based on the leaked iris data, security and robustness of iris information are improved, and the iris information of the user can be effectively prevented from being stolen.

This embodiment is described from a perspective of an object identification apparatus. The object identification apparatus may be integrated into a second electronic device. The second electronic device may be a device such as a terminal or a server.

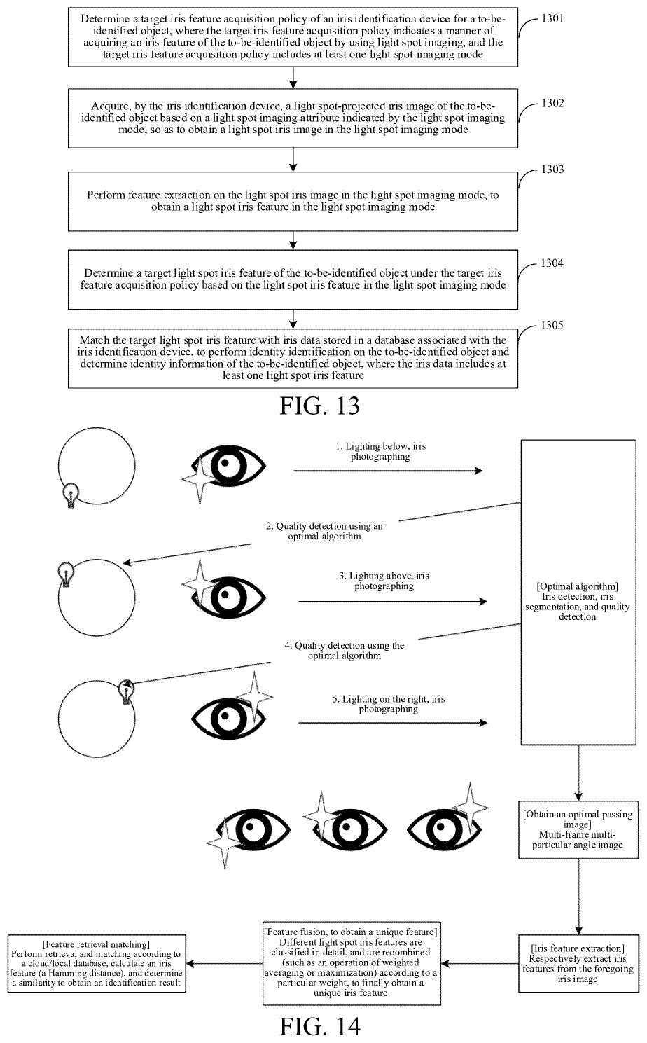

As shown in FIG. 13, a specific flow of the object identification method is as follows:

1301: Determine a target iris feature acquisition policy of an iris identification device for a to-be-identified object, where the target iris feature acquisition policy indicates a manner of acquiring an iris feature of the to-be-identified object by using light spot imaging, and the target iris feature acquisition policy includes at least one light spot imaging mode.

In an example, in this embodiment, when iris identification is performed on the user, the user needs to cooperate to acquire different light spot iris images. When identity authentication is performed, a target iris feature acquisition policy of a to-be-identified object needs to be consistent with an iris feature acquisition policy when the to-be-identified object inputs a light spot iris feature. Otherwise, the identity authentication on the to-be-identified object cannot be passed.

The iris identification device may be configured to acquire an iris feature and perform identity identification on the acquired iris image. For example, the iris identification device may be VR glasses, a door lock, a safe, or the like.

The target iris feature acquisition policy may be set by the iris identification device, or may be defined by the to-be-identified object. In an example, different devices may use different iris feature acquisition policies. In this way, differences between devices may be supported, so that an iris feature acquired by device A can be used only by device A but cannot be used by device B, thereby improving the security of iris identification. In addition, different users may also self-define target iris feature acquisition policies belonging to the users. The defined target iris feature acquisition policy may be used for each iris identification.

In an example, the iris feature acquisition policy includes at least one light spot imaging mode. The light spot imaging mode may be a mode in which a light spot is formed on an iris when the iris is imaged. The light spot may be formed by using a mask. The mask may be located in front of an infrared lamp or a camera lens of the iris identification device. In some embodiments, shapes of masks of different iris identification devices may be different. In this way, shapes of light spots formed under the masks of different shapes are also different. Therefore, the different iris identification devices have different iris feature acquisition policies, thereby differentiating devices of the iris feature acquisition policies, and improving the security of iris identification.

Different light spot imaging modes indicate different light spot imaging attributes. The light spot imaging attribute may refer to an imaging attribute of a light spot on an iris. The imaging attribute herein may include a distribution position of the light spot on the iris, a shape of the light spot, a lighting sequence of the light spot, and the like. This is not limited in this embodiment. The lighting sequence of the light spot is a sequence of executing the light spot imaging modes in the iris feature acquisition policy.

For example, an iris feature acquisition policy may be first applying a light spot below an iris, then applying a light spot above the iris, and finally applying a light spot on the right of the iris. The iris feature acquisition policy includes three light spot imaging modes. The three light spot imaging modes are respectively: applying a light spot below an iris, applying a light spot above the iris, and applying a light spot on the right of the iris.

1302: Acquire, by the iris identification device, a light spot-projected iris image of the to-be-identified object based on a light spot imaging attribute indicated by the light spot imaging mode, so as to obtain a light spot iris image in the light spot imaging mode.

The light spot iris image in the light spot imaging mode includes a light spot formed in the light spot imaging mode. In an example, the light spot iris image may be an infrared image.

In an example, in an iris feature acquisition module of the iris identification device, an infrared image is acquired. An infrared lamp is mapped to an iris of a user, and a light spot is formed. When eyeballs of the user move to different angles, there is a difference in light spot imaging, and there is a difference in iris features obtained through calculation in this way. Similarly, different lighting manners may also cause differences in light spot imaging. Therefore, in some embodiments, different devices may use different lighting manners to differentiate devices for iris identification.

In this embodiment, for different light spot imaging modes, moving directions of the eyeballs of the user may be different. Alternatively, for different light spot imaging modes, different lighting manners may be used. The different lighting manners herein may include different lighting angles, different light spot shapes, or the like. In this way, different light spot imaging modes correspondingly form different light spots, a plurality of frames of different light spot imaging images can be obtained, and all the light spot imaging images are fused into a unique feature.

In this embodiment, the operation of acquiring, by the iris identification device, a light spot-projected iris image of the to-be-identified object based on a light spot imaging attribute indicated by the light spot imaging mode, so as to obtain a light spot iris image in the light spot imaging mode may include:

guiding, by the iris identification device, the to-be-identified object to move eyeballs based on the light spot imaging attribute indicated by the light spot imaging mode, to acquire the light spot-projected iris image of the to-be-identified object, so as to obtain the light spot iris image in the light spot imaging mode.

For example, if the light spot imaging attribute indicated by the light spot imaging mode is that the light spot is applied to the right of the iris, the to-be-identified object may be guided to move the eyeballs to a corresponding angle, so that the light spot is applied to the right of the iris.

In a specific embodiment, the iris identification device may include a display screen. The display screen may present information for guiding the user to move the eyeballs. The user may alternatively be guided to move the eyeballs in another manner.

In this embodiment, the iris identification device includes an image acquisition module and at least one infrared light module. The operation of acquiring, by the iris identification device, a light spot-projected iris image of the to-be-identified object based on a light spot imaging attribute indicated by the light spot imaging mode, so as to obtain a light spot iris image in the light spot imaging mode may include: controlling a lighting manner of the infrared light module to be switched to a target lighting manner based on the light spot imaging attribute indicated by the light spot imaging mode; and acquiring, by the image acquisition module, the light spot-projected iris image of the to-be-identified object based on the target lighting manner, so as to obtain the light spot iris image in the light spot imaging mode.

The image acquisition module may be an image shooting module such as a camera. The lighting manner of the infrared light module may include a lighting angle of an infrared lamp, a correspondingly formed light spot shape, and the like.

For example, if the light spot imaging attribute indicated by the light spot imaging mode is that the light spot is applied to the right of the iris, a lighting angle of the infrared lamp module may be controlled, so that the formed light spot is applied to the right of the iris.

In this embodiment, the operation of controlling a lighting manner of the infrared light module to be switched to a target lighting manner based on the light spot imaging attribute indicated by the light spot imaging mode may include: controlling an on-off state of each infrared light module based on the light spot imaging attribute indicated by the light spot imaging mode, to switch the lighting manner of the infrared light module to the target lighting manner; or, moving a position of the infrared light module based on the light spot imaging attribute indicated by the light spot imaging mode, to switch the lighting manner of the infrared light module to the target lighting manner.

The infrared lamp on the iris identification device may be controlled to be on and off in a preset manner, so as to implement lighting at different angles. The infrared lamp module may alternatively be moved on the iris identification device in a preset motion manner, so as to implement lighting at different angles.

In this embodiment, the light spot imaging modes in the target iris feature acquisition policy are arranged in a preset acquisition sequence.

The operation of acquiring, by the iris identification device, a light spot-projected iris image of the to-be-identified object based on a light spot imaging attribute indicated by the light spot imaging mode, so as to obtain a light spot iris image in the light spot imaging mode may include: determining a target light spot imaging mode to be currently executed from the target iris feature acquisition policy based on the preset acquisition sequence; acquiring, by the iris identification device, the light spot-projected iris image of the to-be-identified object based on the light spot imaging attribute indicated by the target light spot imaging mode, so as to obtain a light spot iris image in the target light spot imaging mode; determining a new target light spot imaging mode to be currently executed from the target iris feature acquisition policy based on the preset acquisition sequence after the light spot iris image in the target light spot imaging mode passes quality detection; and returning to the operation of acquiring, by the iris identification device, a light spot-projected iris image of the to-be-identified object based on a light spot imaging attribute indicated by the light spot imaging mode, so as to obtain a light spot iris image in the light spot imaging mode, until a light spot iris image passing the quality detection in each light spot imaging mode in the target iris feature acquisition policy is obtained.

1303: Perform feature extraction on the light spot iris image in the light spot imaging mode, to obtain a light spot iris feature in the light spot imaging mode.

In this embodiment, the operation of performing feature extraction on the light spot iris image in the light spot imaging mode, to obtain a light spot iris feature in the light spot imaging mode may include: performing iris segmentation processing on the light spot iris image in the light spot imaging mode, to obtain a light spot iris region in the light spot imaging mode; normalizing the light spot iris region to obtain a normalized light spot iris region; and performing feature extraction on the normalized light spot iris region, to obtain the light spot iris feature in the light spot imaging mode.

In an example, before the iris segmentation processing is performed, image preprocessing may be performed on an original light spot iris image in the light spot imaging mode. The image preprocessing herein may include a preprocessing operation such as filtering, histogram equalization, and grayscale. Image quality can be improved through the image preprocessing.

After the light spot iris region in the light spot imaging mode is obtained, quality detection may further be performed on the light spot iris region. The quality detection may include determining of iris eyelash blocking, determining of exposure, determining of eyelid blocking, and the like. A picture of higher quality may be screened out by means of the quality detection.

In this embodiment, the operation of performing iris segmentation processing on the light spot iris image in the light spot imaging mode, to obtain a light spot iris region in the light spot imaging mode may include: calculating gradient information of pixel points in the light spot iris image in the light spot imaging mode; selecting at least one target pixel point from the pixel points of the light spot iris image according to the gradient information; performing a connection operation on the target pixel points, to obtain a closed contour; and performing iris segmentation processing on the light spot iris image according to the closed contour, to obtain the light spot iris region in the light spot imaging mode.

In an embodiment, the operation of normalizing the light spot iris region to obtain a normalized light spot iris region may be: converting different light spot iris regions into same features and metric scales, thereby facilitating subsequent feature extraction and matching. In an example, there are multiple iris normalization methods, for example, a polar coordinate transformation method and a strip projection method.

In this embodiment, the operation of performing feature extraction on the light spot iris image in the light spot imaging mode, to obtain a light spot iris feature in the light spot imaging mode may include: filtering the light spot iris image in the light spot imaging mode, to obtain a response function of each pixel point in the light spot iris image in the light spot imaging mode; extracting frequency information and direction information corresponding to the response function of each pixel point; and mapping the light spot iris image in the light spot imaging mode according to the frequency information and the direction information, to obtain the light spot iris feature in the light spot imaging mode.

The operation of performing feature extraction on the light spot iris image in the light spot imaging mode may include: performing iris segmentation processing on the light spot iris image in the light spot imaging mode, normalizing a light spot iris region obtained by segmentation, and then performing feature extraction on the normalized light spot iris region, to obtain the light spot iris feature in the light spot imaging mode.

The light spot iris feature includes a light spot iris frequency feature and a light spot iris direction feature.

1304: Determine a target light spot iris feature of the to-be-identified object under the target iris feature acquisition policy based on the light spot iris feature in the light spot imaging mode.

In an example, the light spot iris features in the light spot imaging modes may be fused to obtain the target light spot iris feature of the to-be-identified object under the target iris feature acquisition policy. The fusion manner herein may include weighted averaging, and the like. This is not limited in this embodiment.

In this embodiment, different light spot imaging modes indicate different light spot imaging attributes. The operation of determining a target light spot iris feature of the to-be-identified object under the target iris feature acquisition policy based on the light spot iris feature in the light spot imaging mode may include: determining weight information respectively corresponding to the light spot iris features in the light spot imaging modes; and fusing the light spot iris features in the light spot imaging modes according to the weight information respectively corresponding to the light spot iris features in the light spot imaging modes, to obtain the target light spot iris feature of the to-be-identified object under the target iris feature acquisition policy.

Weight information respectively corresponding to the light spot iris features in the light spot imaging modes may be determined according to a definition of the light spot iris feature in each light spot imaging mode.

1305: Match the target light spot iris feature with iris data stored in a database associated with the iris identification device, to perform identity identification on the to-be-identified object and determine identity information of the to-be-identified object, where the iris data includes at least one light spot iris feature.

The iris data includes a light spot iris feature of at least one user under a corresponding iris feature acquisition policy. One light spot iris feature belongs to one user, and one user may have a plurality of light spot iris features in a database.

In this embodiment, the operation of matching the target light spot iris feature with iris data stored in a database associated with the iris identification device, to perform identity identification on the to-be-identified object and determine identity information of the to-be-identified object may include: calculating a matching degree between the target light spot iris feature and each light spot iris feature in the database; and performing identity identification on the to-be-identified object according to the matching degree, to determine the identity information of the to-be-identified object.

Object identity information corresponding to a light spot iris feature having a highest matching degree may be used as the identity information of the to-be-identified object.

In a specific scenario, FIG. 14 shows a detailed process of an object identification method in this disclosure. The following descriptions are provided:

Operation A: As shown in 1 to 5 in FIG. 14, a user may use a self-defined target iris feature acquisition policy to cooperate to acquire an iris, to obtain a plurality of frames of light spot iris images at a particular angle.

In an example, the target iris feature acquisition policy may be first lighting below the iris, then lighting above the iris, and finally lighting on the right of the iris. In a specific acquisition process, a light spot may be applied below an iris, a light spot iris image with the light spot below the iris is acquired, and then quality detection is performed by using an optimal algorithm. After the quality detection is passed, a light spot is applied above an iris, a light spot iris image with the light spot above the iris is acquired, and then quality detection is performed by using the optimal algorithm. After the quality detection is passed, a light spot is applied on the right of an iris, a light spot iris image with the light spot on the right of the iris is acquired, and then quality detection is performed by using the optimal algorithm.

The optimal algorithm may include an iris detection algorithm, an iris segmentation algorithm, and a quality detection algorithm. An objective of iris detection, iris segmentation, and quality detection is to screen out a picture with relatively good quality, so as to facilitate feature extraction.

Operation B: after optimal acquisition in operation A, a plurality of frames of high-quality multi-angle iris images with light spots are obtained.

Operation C: Iris feature extraction: Iris segmentation is performed on the light spot iris image to obtain a light spot iris region, which is normalized. Then, feature extraction is performed on the normalized light spot iris region, to obtain the light spot iris feature in each light spot imaging mode.

In this embodiment, the light spot is directly reserved, and the iris feature is calculated.

Operation D: Feature fusion is performed to obtain a unique feature: Different light spot iris features are classified in detail, and are recombined (such as an operation of weighted averaging or maximization) according to a particular weight, to finally obtain a unique iris feature, namely a target light spot iris feature under a target iris feature acquisition policy.

### Operation E: Feature Retrieval Matching

The target light spot iris feature calculated in operation D is usually stored in a local database or a server cloud database. During identity authentication or identification, a most similar iris feature needs to be retrieved and matched from the database, to implement identity authentication or identity identification.

The iris features in the database may be stored in a feature vector manner. Each iris feature vector corresponds to a unique identity identifier. When identity authentication or identification needs to be performed, an eigenvector of a to-be-authenticated iris needs to be inputted, and then an eigenvector most similar to a feature of the to-be-authenticated iris is retrieved and matched from the database, to obtain a result of identity authentication or identification.

An iris matching algorithm may include a Euclidean distance, cosine similarity, a Mahalanobis distance, a Hamming distance, and the like. A specific matching manner and a similarity measurement method need to be selected according to an actual situation.

The Euclidean distance is used as an example. A to-be-authenticated iris feature vector (namely, the target light spot iris feature) is set as x, a group of iris feature vectors in the database is y, and the Euclidean distance therebetween is d(x, y). Therefore, an iris feature vector most similar to the to-be-authenticated iris in the database may be calculated according to Formula (7):

$$\hat{y} = arg {min}_{y ∈ database} d ( x , y ) \qquad ( 7 )$$

where ŷ represents the iris feature vector most similar to the to-be-authenticated iris in the database. database represents the database.

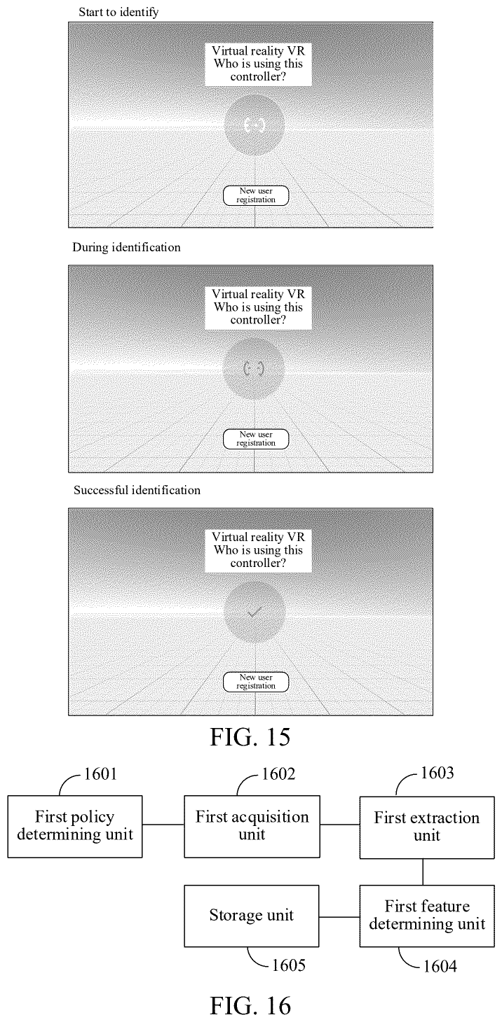

In a specific scenario, FIG. 15 shows a schematic diagram of iris identification interaction of a VR device. A custom camera holder may be added to the VR device. The camera holder has an infrared lamp and an infrared camera, and a user iris image may be acquired. A detailed identification process is provided.

1. Start to identify: A user gazes at a front circle, and identification automatically starts. In an example, a range of a gazing point of the user may be determined by using a gyroscope or eye capture, to determine an identification intention of the user. If the range of the gazing point of the user is out of the front circle, the user does not have the identification intention, and identification is not performed.

2. During identification: A device lighting position is changed, or the user is guided to move eyeballs. Meanwhile, the camera acquires a plurality of frames of images with light spots in the iris, and images are fused into a unique feature.

3. Successful identification: After the matching and identification succeeds, a check mark is displayed, and then an internal interface of a VR system or an application is entered.

In an example, in this embodiment, a terminal is required to have a capability of running an optimal algorithm, a graphics rendering capability, a database storage capability, and a capability of satisfying running performance of identification logic. This embodiment allows online identification and local identification. If networking is considered, a terminal device is required to have a network connection capability, and a background identification service needs to be set up.

In this embodiment, a target iris feature acquisition policy of an iris identification device for a to-be-identified object is determined, where the target iris feature acquisition policy indicates a manner of acquiring an iris feature of the to-be-identified object by using light spot imaging, and the target iris feature acquisition policy includes at least one light spot imaging mode. The iris identification device acquires a light spot-projected iris image of the to-be-identified object based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a target light spot iris feature of the to-be-identified object under the target iris feature acquisition policy is determined. The target light spot iris feature is matched with iris data stored in a database associated with the iris identification device, to perform identity identification on the to-be-identified object and determine identity information of the to-be-identified object, where the iris data includes at least one light spot iris feature.

In this disclosure, an iris image may be encrypted by using light spot imaging, and corresponding encrypted iris features are stored into a database. For a to-be-identified object, only when an iris feature of the to-be-identified object is acquired by using a corresponding iris feature acquisition policy, the to-be-identified object can be identified by using an iris. If iris data of the database is leaked, because a real iris feature of a user cannot be directly obtained based on the leaked iris data, security and robustness of iris information are improved, and an iris identification device can be effectively prevented from being deceived by stolen iris information.

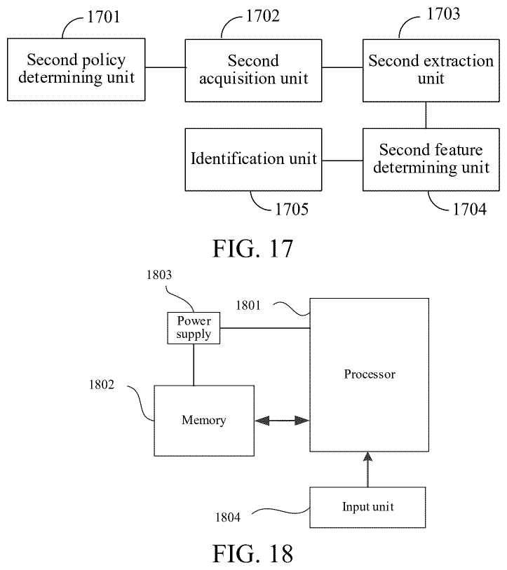

To better implement the foregoing method, an embodiment of this disclosure further provides an iris feature acquisition and object identification system. The iris feature acquisition and object identification system includes an iris feature acquisition apparatus 31 and an object identification apparatus 32. As shown in FIG. 16, the iris feature acquisition apparatus 31 may include a first policy determining unit 1601, a first acquisition unit 1602, a first extraction unit 1603, a first feature determining unit 1604, and a storage unit 1605. As shown in FIG. 17, the object identification apparatus 32 may include a second policy determining unit 1701, a second acquisition unit 1702, a second extraction unit 1703, a second feature determining unit 1704, and an identification unit 1705.

### A. Iris Feature Acquisition Apparatus 31

### (1) First Policy Determining Unit 1601

The first policy determining unit is configured to determine an iris feature acquisition policy of an iris identification device for a user, where the iris feature acquisition policy indicates a manner of acquiring an iris feature by using light spot imaging, and the iris feature acquisition policy includes at least one light spot imaging mode.

### (2) First Acquisition Unit 1602

The first acquisition unit is configured to acquire, by the iris identification device, a light spot-projected iris image of the user based on a light spot imaging attribute indicated by the light spot imaging mode, so as to obtain a light spot iris image in the light spot imaging mode.

In some embodiments of this disclosure, the first acquisition unit may be configured to guide, by the iris identification device, the user to move eyeballs based on the light spot imaging attribute indicated by the light spot imaging mode, to acquire the light spot-projected iris image of the user, so as to obtain the light spot iris image in the light spot imaging mode.

In some embodiments of this disclosure, the iris identification device includes an image acquisition module and at least one infrared light module.

The first acquisition unit may include a control subunit and an acquisition subunit.

The control subunit is configured to control a lighting manner of the infrared light module to be switched to a target lighting manner based on the light spot imaging attribute indicated by the light spot imaging mode.

The acquisition subunit is configured to acquire, by the image acquisition module, the light spot-projected iris image of the user based on the target lighting manner, so as to obtain the light spot iris image in the light spot imaging mode.

In some embodiments of this disclosure, the control subunit may be configured to control an on-off state of each infrared light module based on the light spot imaging attribute indicated by the light spot imaging mode, to switch the lighting manner of the infrared light module to the target lighting manner. Alternatively, a position of the infrared light module is moved based on the light spot imaging attribute indicated by the light spot imaging mode, to switch the lighting manner of the infrared light module to the target lighting manner.

In some embodiments of this disclosure, the light spot imaging modes in the iris feature acquisition policy are arranged in a preset acquisition sequence.

The first acquisition unit may include a first mode determining subunit, an image acquisition subunit, a second mode determining subunit, and a return subunit.

The first mode determining subunit is configured to determine a target light spot imaging mode to be currently executed from the iris feature acquisition policy based on the preset acquisition sequence.

The image acquisition subunit is configured to acquire, by the iris identification device, the light spot-projected iris image of the user based on the light spot imaging attribute indicated by the target light spot imaging mode, so as to obtain a light spot iris image in the target light spot imaging mode.

The second mode determining subunit is configured to determine a new target light spot imaging mode to be currently executed from the iris feature acquisition policy based on the preset acquisition sequence after the light spot iris image in the target light spot imaging mode passes quality detection.

The return subunit is configured to return to the operation of acquiring, by the iris identification device, a light spot-projected iris image of the user based on a light spot imaging attribute indicated by the light spot imaging mode, so as to obtain a light spot iris image in the light spot imaging mode, until a light spot iris image passing the quality detection in each light spot imaging mode in the iris feature acquisition policy is obtained.

### (3) First Extraction Unit 1603

The first extraction unit is configured to perform feature extraction on the light spot iris image in the light spot imaging mode, to obtain a light spot iris feature in the light spot imaging mode.

In some embodiments of this disclosure, the first extraction unit may include a segmentation subunit, a normalization subunit, and an extraction subunit.

The segmentation subunit is configured to perform iris segmentation processing on the light spot iris image in the light spot imaging mode, to obtain a light spot iris region in the light spot imaging mode.

The normalization subunit is configured to normalize the light spot iris region to obtain a normalized light spot iris region.

The extraction subunit is configured to perform feature extraction on the normalized light spot iris region, to obtain the light spot iris feature in the light spot imaging mode

In some embodiments of this disclosure, the segmentation subunit may be configured to: calculate gradient information of pixel points in the light spot iris image in the light spot imaging mode; select at least one target pixel point from the pixel points of the light spot iris image according to the gradient information; perform a connection operation on the target pixel points, to obtain a closed contour; and perform iris segmentation processing on the light spot iris image according to the closed contour, to obtain the light spot iris region in the light spot imaging mode.

In some embodiments of this disclosure, the first extraction unit may include a filtering subunit, an information extraction subunit, and a mapping subunit.

The filtering subunit is configured to filter the light spot iris image in the light spot imaging mode, to obtain a response function of each pixel point in the light spot iris image in the light spot imaging mode.

The information extraction subunit is configured to extract frequency information and direction information corresponding to the response function of each pixel point.

The mapping subunit is configured to map the light spot iris image in the light spot imaging mode according to the frequency information and the direction information, to obtain the light spot iris feature in the light spot imaging mode.

### (4) First Feature Determining Unit 1604

The first feature determining unit is configured to determine a light spot iris feature of the user (also referred to as light spot iris identification feature of the user) under the iris feature acquisition policy based on the light spot iris feature in the light spot imaging mode.

In some embodiments of this disclosure, different light spot imaging modes indicate different light spot imaging attributes.

The first feature determining unit may include a first weight determining subunit and a first fusion subunit.

The first weight determining subunit is configured to determine weight information respectively corresponding to the light spot iris features in the light spot imaging modes.

The first fusion subunit is configured to fuse the light spot iris features in the light spot imaging modes according to the weight information respectively corresponding to the light spot iris features in the light spot imaging modes, to obtain the light spot iris feature of the user for iris identification under the iris feature acquisition policy.

### (5) Storage Unit 1605

The storage unit is configured to store the light spot iris feature of the user under the iris feature acquisition policy into a database associated with the iris identification device.

### B. Object Identification Apparatus 32

### (6) Second Policy Determining Unit 1701

The second policy determining unit is configured to determine a target iris feature acquisition policy of an iris identification device for a to-be-identified object, where the target iris feature acquisition policy indicates a manner of acquiring an iris feature of the to-be-identified object by using light spot imaging, and the target iris feature acquisition policy includes at least one light spot imaging mode.

### (7) Second Acquisition Unit 1702

The second acquisition unit is configured to acquire, by the iris identification device, a light spot-projected iris image of the to-be-identified object based on a light spot imaging attribute indicated by the light spot imaging mode, so as to obtain a light spot iris image in the light spot imaging mode.

### (8) Second Extraction Unit 1703

The second extraction unit is configured to perform feature extraction on the light spot iris image in the light spot imaging mode, to obtain a light spot iris feature in the light spot imaging mode.

### (9) Second Feature Determining Unit 1704

The second feature determining unit is configured to determine a target light spot iris feature of the to-be-identified object under the target iris feature acquisition policy based on the light spot iris feature in the light spot imaging mode.

In some embodiments of this disclosure, different light spot imaging modes indicate different light spot imaging attributes.

The second feature determining unit may include a second weight determining subunit and a second fusion subunit.

The second weight determining subunit is configured to determine weight information respectively corresponding to the light spot iris features in the light spot imaging modes.

The second fusion subunit is configured to fuse the light spot iris features in the light spot imaging modes according to the weight information respectively corresponding to the light spot iris features in the light spot imaging modes, to obtain the target light spot iris feature of the to-be-identified object under the target iris feature acquisition policy.

### (10) Identification Unit 1705

The identification unit is configured to match the target light spot iris feature with iris data stored in a database associated with the iris identification device, to perform identity identification on the to-be-identified object and determine identity information of the to-be-identified object, where the iris data includes at least one light spot iris feature.

In this embodiment, the first policy determining unit 1601 may determine an iris feature acquisition policy of an iris identification device for a user, where the iris feature acquisition policy indicates a manner of acquiring an iris feature by using light spot imaging, and the iris feature acquisition policy includes at least one light spot imaging mode. The first acquisition unit 1602 acquires, by the iris identification device, a light spot-projected iris image of the user based on a light spot imaging attribute indicated by the light spot imaging mode, so as to obtain a light spot iris image in the light spot imaging mode. The first extraction unit 1603 performs feature extraction on the light spot iris image in the light spot imaging mode, to obtain a light spot iris feature in the light spot imaging mode. The first feature determining unit 1604 determines a light spot iris feature of the user under the iris feature acquisition policy based on the light spot iris feature in the light spot imaging mode. The storage unit 1605 stores the light spot iris feature of the user under the iris feature acquisition policy into a database associated with the iris identification device.

Alternatively, the second policy determining unit 1701 determines a target iris feature acquisition policy of an iris identification device for a to-be-identified object, where the target iris feature acquisition policy indicates a manner of acquiring an iris feature of the to-be-identified object by using light spot imaging, and the target iris feature acquisition policy includes at least one light spot imaging mode. The second acquisition unit 1702 acquires, by the iris identification device, a light spot-projected iris image of the to-be-identified object based on a light spot imaging attribute indicated by the light spot imaging mode, so as to obtain a light spot iris image in the light spot imaging mode. The second extraction unit 1703 performs feature extraction on the light spot iris image in the light spot imaging mode, to obtain a light spot iris feature in the light spot imaging mode. The second feature determining unit 1704 determines a target light spot iris feature of the to-be-identified object under the target iris feature acquisition policy based on the light spot iris feature in the light spot imaging mode. The identification unit 1705 matches the target light spot iris feature with iris data stored in a database associated with the iris identification device, to perform identity identification on the to-be-identified object and determine identity information of the to-be-identified object, where the iris data includes at least one light spot iris feature.

In this disclosure, an iris image may be encrypted by using light spot imaging, and corresponding encrypted iris features are stored into a database. For a to-be-identified object, only when an iris feature of the to-be-identified object is acquired by using a corresponding iris feature acquisition policy, the to-be-identified object can be identified by using an iris. If iris data of the database is leaked, because a real iris feature of a user cannot be directly obtained based on the leaked iris data, security and robustness of iris information are improved, and an iris identification device can be effectively prevented from being deceived by stolen iris information.

An embodiment of this disclosure further provides an electronic device. FIG. 18 shows a schematic diagram of a structure of an electronic device according to an embodiment of this disclosure. The electronic device may be a terminal or a server.

The electronic device may include components such as a processor 1801 of one or more processing cores, a memory 1802 of one or more computer-readable storage media, a power supply 1803, and an input unit 1804. The structure of the electronic device shown in FIG. 18 does not constitute a limit to the electronic device. The server may include more or fewer parts than those shown in the figure, may combine some parts, or may have different part arrangements. In the electronic device:

The processor 1801 is a control center of the electronic device, which is connected to various parts of the entire electronic device by using various interfaces and lines, and by running or executing a software program and/or module stored in the memory 1802 and calling data stored in the memory 1802, to implement various functions of the electronic device and process data. In some embodiments, the processor 1801 may include one or more processing cores. In some examples, an application processor and a modem processor may be integrated into the processor 1801. The application processor mainly processes an operating system, a user interface, an application, and the like. The modem processor mainly processes wireless communication. The foregoing modem may either not be integrated into the processor 1801.

The memory 1802 may be configured to store a software program and a module. The processor 1801 runs the software program and the modules that are stored in the memory 1802, to implement various functional applications and data processing. The memory 1802 may mainly include a program storage area and a data storage area. The program storage area may store an operating system, an application required for at least one function (for example, a sound playback function and an image playback function), and the like. The storage data area may store data or the like created according to the use of the electronic device. In addition, the memory 1802 may include a high speed random access memory, and may alternatively include a non-volatile memory, such as at least one magnetic disk storage device, a flash memory, or another volatile solid-state storage device. Correspondingly, the memory 1802 may further include a memory controller, to provide access of the processor 1801 to the memory 1802.

The electronic device further includes a power supply 1803 for supplying power to the various components. In some examples, the power supply 1803 may be logically connected to the processor 1801 by using a power management system, thereby implementing functions such as charging, discharging, and power consumption management by using the power management system. The power supply 1803 may further include one or more of a direct current or alternating current power supply, a re-charging system, a power failure detection circuit, a power supply converter or inverter, a power supply state indicator, and any other components.

The electronic device may further include the input unit 1804. The input unit 1804 may be configured to receive entered numeric or character information and generate keyboard, mouse, joystick, optical, or trackball signal input related to user settings and function control.

Although not shown, the electronic device may further include a display unit, and the like. Details are not described herein again. In an example, in this embodiment, the processor 1801 in the electronic device may load, according to the following instructions, executable files corresponding to processes of one or more applications into the memory 1802. The processor 1801 runs the applications stored in the memory 1802, to implement various functions. For example:

An iris feature acquisition policy of an iris identification device for a user is determined, where the iris feature acquisition policy indicates a manner of acquiring an iris feature by using light spot imaging, and the iris feature acquisition policy includes at least one light spot imaging mode. The iris identification device acquires a light spot-projected iris image of the user based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a light spot iris feature of the user under the iris feature acquisition policy is determined. The light spot iris feature of the user under the iris feature acquisition policy is stored into a database associated with the iris identification device.

Alternatively, a target iris feature acquisition policy of an iris identification device for a to-be-identified object is determined, where the target iris feature acquisition policy indicates a manner of acquiring an iris feature of the to-be-identified object by using light spot imaging, and the target iris feature acquisition policy includes at least one light spot imaging mode. The iris identification device acquires a light spot-projected iris image of the to-be-identified object based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a target light spot iris feature of the to-be-identified object under the target iris feature acquisition policy is determined. The target light spot iris feature is matched with iris data stored in a database associated with the iris identification device, to perform identity identification on the to-be-identified object and determine identity information of the to-be-identified object, where the iris data includes at least one light spot iris feature.

For specific implementations of the above operations, refer to the foregoing embodiments. Details are not described herein again.

In this embodiment, an iris feature acquisition policy of an iris identification device for a user is determined, where the iris feature acquisition policy indicates a manner of acquiring an iris feature by using light spot imaging, and the iris feature acquisition policy includes at least one light spot imaging mode. The iris identification device acquires a light spot-projected iris image of the user based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a light spot iris feature of the user under the iris feature acquisition policy is determined. The light spot iris feature of the user under the iris feature acquisition policy is stored into a database associated with the iris identification device.

Alternatively, a target iris feature acquisition policy of an iris identification device for a to-be-identified object is determined, where the target iris feature acquisition policy indicates a manner of acquiring an iris feature of the to-be-identified object by using light spot imaging, and the target iris feature acquisition policy includes at least one light spot imaging mode. The iris identification device acquires a light spot-projected iris image of the to-be-identified object based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a target light spot iris feature of the to-be-identified object under the target iris feature acquisition policy is determined. The target light spot iris feature is matched with iris data stored in a database associated with the iris identification device, to perform identity identification on the to-be-identified object and determine identity information of the to-be-identified object, where the iris data includes at least one light spot iris feature.

In this disclosure, an iris image may be encrypted by using light spot imaging, and corresponding encrypted iris features are stored into a database. For a to-be-identified object, only when an iris feature of the to-be-identified object is acquired by using a corresponding iris feature acquisition policy, the to-be-identified object can be identified by using an iris. If iris data of the database is leaked, because a real iris feature of a user cannot be directly obtained based on the leaked iris data, security and robustness of iris information are improved, and an iris identification device can be effectively prevented from being deceived by stolen iris information.

All or some operations of the methods in the foregoing embodiments may be implemented by using instructions, or implemented through instructions controlling relevant hardware, and the instructions may be stored in a computer-readable memory and loaded and executed by a processor.

Accordingly, an embodiment of this disclosure provides a computer-readable storage medium, having a plurality of instructions stored therein. The instructions can be loaded by the processor, to perform the operations in any iris feature acquisition method and object identification method provided in the foregoing embodiments of this disclosure. For example, the instructions may perform the following operations.

An iris feature acquisition policy of an iris identification device for a user is determined, where the iris feature acquisition policy indicates a manner of acquiring an iris feature by using light spot imaging, and the iris feature acquisition policy includes at least one light spot imaging mode. The iris identification device acquires a light spot-projected iris image of the user based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a light spot iris feature of the user under the iris feature acquisition policy is determined. The light spot iris feature of the user under the iris feature acquisition policy is stored into a database associated with the iris identification device.

Alternatively, a target iris feature acquisition policy of an iris identification device for a to-be-identified object is determined, where the target iris feature acquisition policy indicates a manner of acquiring an iris feature of the to-be-identified object by using light spot imaging, and the target iris feature acquisition policy includes at least one light spot imaging mode. The iris identification device acquires a light spot-projected iris image of the to-be-identified object based on a light spot imaging attribute indicated by the light spot imaging mode, so as to obtain a light spot iris image in the light spot imaging mode. Feature extraction is performed on the light spot iris image in the light spot imaging mode, to obtain a light spot iris feature in the light spot imaging mode. Based on the light spot iris feature in the light spot imaging mode, a target light spot iris feature of the to-be-identified object under the target iris feature acquisition policy is determined. The target light spot iris feature is matched with iris data stored in a database associated with the iris identification device, to perform identity identification on the to-be-identified object and determine identity information of the to-be-identified object, where the iris data includes at least one light spot iris feature.

For specific implementations of the above operations, refer to the foregoing embodiments. Details are not described herein again.

The computer-readable storage medium may include: a read-only memory (ROM), a random access memory (RAM), a magnetic disk, an optical disc, or the like.

Since the instruction stored in the computer-readable storage medium may perform the operations in any iris feature acquisition method or object identification method according to the foregoing embodiments of this disclosure, advantageous effects that can be implemented by any iris feature acquisition method or object identification method according to the foregoing embodiments of this disclosure may be implemented. The foregoing embodiments may be referred to for details. Details are not described herein again.

According to an aspect of this disclosure, a computer program product or a computer program is provided. The computer program product or the computer program includes a computer instruction. The computer instruction is stored in a computer-readable storage medium. A processor of a computer device reads the computer instruction from the computer-readable storage medium. The processor executes the computer instruction, so that the computer device is enabled to perform the method provided in various implementations in terms of the foregoing iris feature acquisition and object identification.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The technical features of the foregoing embodiments may be combined. To make description concise, not all combinations of the technical features in the foregoing embodiments are described. However, the combinations of these technical features shall be considered as falling within the scope recorded by this specification provided that no conflict exists.

The foregoing disclosure includes some embodiments of this disclosure which are not intended to limit the scope of this disclosure. Other embodiments shall also fall within the scope of this disclosure.

What is claimed is:

1. A method of iris feature acquisition, the method comprising:
determining an iris feature acquisition policy of an iris identification device for a user, the iris feature acquisition policy indicating a manner of acquiring an iris feature by using light spot imaging, the iris feature acquisition policy comprising one or more light spot imaging modes, and the iris feature acquisition policy being determined based on at least one of information of the iris identification device and information of the user;
acquiring, by using the iris identification device, one or more light spot iris images of the user respectively based on the one or more light spot imaging modes, the one or more light spot imaging modes indicating light spot imaging attributes of the iris identification device;
performing feature extraction respectively on the one or more light spot iris images to obtain one or more light spot iris features respectively in the one or more light spot imaging modes;
determining a light spot iris identification feature of the user under the iris feature acquisition policy based on the one or more light spot iris features respectively in the one or more light spot imaging modes; and
storing the light spot iris identification feature of the user under the iris feature acquisition policy with identification information of the user into a database associated with the iris identification device.

2. The method according to claim 1, wherein:
the one or more light spot imaging modes comprise a plurality of light spot imaging modes that have different light spot imaging attributes, and the one or more light spot iris features comprise a plurality of light spot iris features respectively in the plurality of light spot imaging modes; and
the determining the light spot iris identification feature comprises:
determining weight values respectively associated with the plurality of light spot iris features; and
fusing the plurality of light spot iris features according to the weight values, to obtain the light spot iris identification feature of the user for iris identification under the iris feature acquisition policy.

3. The method according to claim 1, wherein the acquiring the one or more light spot iris images comprises:
guiding, by using the iris identification device, the user to move eyeballs based on first light spot imaging attributes indicated by a first light spot imaging mode in the one or more light spot imaging modes, to acquire a first light spot iris image of the user in the first light spot imaging mode.

4. The method according to claim 1, wherein:
the iris identification device comprises an image acquisition module and at least one infrared light module; and
the acquiring the one or more light spot iris images comprises:
controlling the at least one infrared light module into a target lighting manner based on first light spot imaging attributes indicated by a first light spot imaging mode in the one or more light spot imaging modes; and
acquiring, by using the image acquisition module, a first light spot iris image of the user when the at least one infrared light module is in the target lighting manner.

5. The method according to claim 4, wherein:
the at least one infrared light module comprises a plurality of infrared light modules, and
the controlling comprises:
controlling respective on-off states of the plurality of infrared light modules based on the first light spot imaging attributes that are indicated by the first light spot imaging mode.

6. The method according to claim 4, wherein the controlling comprises:
moving the at least one infrared light module to one or more positions based on the first light spot imaging attributes that are indicated by the first light spot imaging mode.

7. The method according to claim 1, wherein:
the iris feature acquisition policy comprises a plurality of light spot imaging modes that are arranged in a preset acquisition sequence; and
the acquiring comprises:
acquiring, by using the iris identification device, respective light spot iris images of the user in the plurality of light spot imaging modes according to the preset acquisition sequence.

8. The method according to claim 1, wherein the performing the feature extraction comprises:
performing an iris segmentation processing on a first light spot iris image in a first light spot imaging mode of the one or more light spot imaging modes, to obtain a first light spot iris region from the first light spot iris image;
normalizing the first light spot iris region to obtain a normalized first light spot iris region; and
performing a feature extraction on the normalized first light spot iris region, to obtain a first light spot iris feature in the first light spot imaging mode.

9. The method according to claim 8, wherein the performing the iris segmentation processing comprises:
calculating gradient information of pixel points in the first light spot iris image;
selecting a plurality of target pixel points from the pixel points of the first light spot iris image according to the gradient information;
performing a connection operation on the plurality of target pixel points, to obtain a closed contour; and
performing an iris segmentation processing on the first light spot iris image according to the closed contour, to obtain the first light spot iris region.

10. The method according to claim 1, wherein the performing the feature extraction comprises:
filtering a first light spot iris image in a first light spot imaging mode of the one or more light spot imaging modes, to obtain respective response functions of pixel points in the first light spot iris image;
extracting frequency information and direction information of the pixel points according to the respective response functions of the pixel points; and
mapping the frequency information and the direction information of the pixel points, to obtain a first light spot iris feature in the first light spot imaging mode.

11. A method of object identification, the method comprising:
determining a target iris feature acquisition policy of an iris identification device for a to-be-identified object, the target iris feature acquisition policy indicating a manner of acquiring an iris feature of the to-be-identified object by using light spot imaging, the target iris feature acquisition policy comprising one or more light spot imaging modes, and the target iris feature acquisition policy being determined based on at least one of information of the iris identification device and information of the to-be-identified object;
acquiring, by using the iris identification device, one or more light spot iris images of the to-be-identified object respectively based on the one or more light spot imaging modes, the one or more light spot imaging modes indicating light spot imaging attributes of the iris identification device;
performing feature extraction respectively on the one or more light spot iris images, to obtain one or more light spot iris features respectively in the one or more light spot imaging modes;
determining a target light spot iris identification feature of the to-be-identified object based on the one or more light spot iris features respectively in the one or more light spot imaging modes; and
matching the target light spot iris identification feature with iris data stored in a database associated with the iris identification device, to determine identity information of the to-be-identified object, the iris data comprising light spot iris identification features with respective identity information.

12. The method according to claim 11, wherein:
the one or more light spot imaging modes comprise a plurality of light spot imaging modes that have different light spot imaging attributes, and the one or more light spot iris features comprise a plurality of light spot iris features respectively in the plurality of light spot imaging modes; and
the determining the target light spot iris identification feature comprises:
determining weight values respectively associated with the plurality of light spot iris features; and
fusing the plurality of light spot iris features according to the weight values to obtain the target light spot iris identification feature of the to-be-identified object under the target iris feature acquisition policy.

13. An apparatus of iris feature acquisition, comprising processing circuitry configured to:
determine an iris feature acquisition policy of an iris identification device for a user, the iris feature acquisition policy indicating a manner of acquiring an iris feature by using light spot imaging, and the iris feature acquisition policy comprising one or more light spot imaging modes, the iris feature acquisition policy being determined based on at least one of information of the iris identification device and information of the user;
acquire, by using the iris identification device, one or more light spot iris images of the user respectively based on the one or more light spot imaging modes, the one or more light spot imaging modes indicating light spot imaging attributes of the iris identification device;
perform feature extraction respectively on the one or more light spot iris images to obtain one or more light spot iris features respectively in the one or more light spot imaging modes;
determine a light spot iris identification feature of the user under the iris feature acquisition policy based on the one or more light spot iris features respectively in the one or more light spot imaging modes; and
store the light spot iris identification feature of the user under the iris feature acquisition policy with identification information of the user into a database associated with the iris identification device.

14. The apparatus according to claim 13, wherein:
the one or more light spot imaging modes comprise a plurality of light spot imaging modes that have different light spot imaging attributes, and the one or more light spot iris features comprise a plurality of light spot iris features respectively in the plurality of light spot imaging modes; and
the processing circuitry is configured to:
determine weight values respectively associated with the plurality of light spot iris features; and
fuse the plurality of light spot iris features according to the weight values, to obtain the light spot iris identification feature of the user for iris identification under the iris feature acquisition policy.

15. The apparatus according to claim 13, wherein the processing circuitry is configured to:
guide, by using the iris identification device, the user to move eyeballs based on first light spot imaging attributes indicated by a first light spot imaging mode in the one or more light spot imaging modes, to acquire a first light spot iris image of the user in the first light spot imaging mode.

16. The apparatus according to claim 13, wherein:
the iris identification device comprises an image acquisition module and at least one infrared light module; and
the processing circuitry is configured to:
control the at least one infrared light module into a target lighting manner based on first light spot imaging attributes indicated by a first light spot imaging mode in the one or more light spot imaging modes; and
acquire, by using the image acquisition module, a first light spot iris image of the user when the at least one infrared light module is in the target lighting manner.

17. The apparatus according to claim 16, wherein:
the at least one infrared light module comprises a plurality of infrared light modules, and
the processing circuitry is configured to:
control respective on-off states of the plurality of infrared light modules based on the first light spot imaging attributes that are indicated by the first light spot imaging mode.

18. The apparatus according to claim 16, wherein the processing circuitry is configured to:
move the at least one infrared light module to one or more positions based on the first light spot imaging attributes that are indicated by the first light spot imaging mode.

19. The apparatus according to claim 13, wherein:
the iris feature acquisition policy comprises a plurality of light spot imaging modes that are arranged in a preset acquisition sequence; and
the processing circuitry is configured to:
acquire, by the iris identification device, respective light spot iris images of the user in the plurality of light spot imaging modes according to the preset acquisition sequence.

20. The apparatus according to claim 13, wherein the processing circuitry is configured to:
perform an iris segmentation processing on a first light spot iris image in a first light spot imaging mode of the one or more light spot imaging modes, to obtain a first light spot iris region from the first light spot iris image;
normalize the first light spot iris region to obtain a normalized first light spot iris region; and
perform a feature extraction on the normalized first light spot iris region, to obtain a first light spot iris feature in the first light spot imaging mode.
